(19) United States
(12) Patent Application Publication
(10) Pub. No.: US 2014/0272865 A1
(43) Pub. Date: Sep. 18, 2014

(54) Physics Engine for Virtual Reality Surgical Training Simulator

(71) Applicant: Peter KIM, Washington, DC (US)

(72) Inventor: Peter KIM, Washington, DC (US)

(21) Appl. No.: 14/063,328

(22) Filed: Oct. 25, 2013

Related U.S. Application Data
(60) Provisional application No. 61/790,573, filed on Mar. 15, 2013.

(51) Int. Cl. G09B 23/28

(52) U.S. Cl. CPC G09B 23/28
USPC 434/262

(57) ABSTRACT

Exemplary embodiments of a virtual reality surgical training simulator may be described. A virtual reality surgical training simulator may have a rendering engine, a physics engine, a metrics engine, a graphical user interface, and a human machine interface. The rendering engine can display a three-dimensional representation of a surgical site containing visual models of organs and surgical tools located at the surgical site. The physics engine can perform a variety of calculations in real time to represent realistic motions of the tools, organs, and anatomical environment. A graphical user interface can be present to allow a user to control a simulation. Finally, a metrics engine may be present to evaluate user performance and skill based on a variety of parameters that can be tracked during a simulation.

### CROSS REFERENCE TO RELATED APPLICATIONS

This application claims priority from U.S. Provisional Patent Application No. 61/790,573, filed Mar. 15, 2013, and entitled SYSTEM, METHOD, AND COMPUTER PRODUCT FOR VIRTUAL REALITY SURGICAL TRAINING SIMULATOR, the entire contents of which are hereby incorporated by reference.

### BACKGROUND

Simulation is a training technique used in a variety of contexts to show the effects of a particular course of action. Well-known simulators include computer flight simulators used to train pilots or for entertainment and even games like Atari's Battlezone, which was adapted by the U.S. Army to form the basis of an armored vehicle gunnery simulator. Simulators can range from simpler computer-based simulators configured to receive input from a single input device (e.g. a joystick) to complex flight simulators using an actual flight deck or driving simulators having a working steering wheel and a car chassis mounted on a gimbal to simulate the forces experienced while driving a car and the effects of various steering and command inputs provided through the steering wheel.

Surgical simulation platforms exist to allow for teaching and training of a variety of surgical techniques and specific surgical procedures in a safe environment where errors would not lead to life-threatening complications. Typical surgical simulation platforms can be physical devices that are anatomically correct models of an entire human body or a portion of the human body (for example, a chest portion for simulating cardiothoracic surgery or an abdomen portion for simulating digestive system surgery). Further, human analogues for surgical training can come in a variety of sizes to simulate surgery on an adult, child, or baby, and some simulators can be gendered to provide for specialized training for gender-specific surgeries (for example, gynecological surgery, caesarian section births, or orchidectomies/orchiectomies).

While physical surgical platforms are commonly used, physical simulation is not always practical. For example, it is difficult to simulate various complications of surgery with a physical simulation. Further, as incisions are made in physical surgical simulators, physical simulators may require replacement over time and can limit the number of times a physical simulator can be used before potentially expensive replacement parts must be procured and installed.

Virtual reality surgical simulation platforms also are available to teach and train surgeons in a variety of surgical procedures. These platforms are often used to simulate non-invasive surgeries; in particular, a variety of virtual surgical simulation platforms exist for simulating a variety of laparoscopic surgeries. Virtual reality surgical simulators typically include a variety of tools that can be connected to the simulator to provide inputs and allow for a simulation of a surgical procedure.

User interfaces for virtual reality surgical simulation platforms often rely on the use of a keyboard and pointing device to make selections during a surgical simulation. Further, graphical user interfaces for virtual reality surgical simulation platforms often present a multitude of buttons that limit that amount of screen space that can be used to display a simulation. Such interfaces can be unintuitive and require excess time for a user to perform various tasks during a simulation.

### SUMMARY

Exemplary embodiments of a virtual reality surgical training simulator may be described. A virtual reality surgical training simulator may have a rendering engine, a physics engine, a metrics engine, a graphical user interface, and a human machine interface. The rendering engine can display a three-dimensional representation of a surgical site containing visual models of organs and surgical tools located at the surgical site. The physics engine can perform a variety of calculations in real time to represent realistic motions of the tools, organs, and anatomical environment. A graphical user interface can be present to allow a user to control a simulation. Finally, a metrics engine may be present to evaluate user performance and skill based on a variety of parameters that can be tracked during a simulation.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 shows an exemplary system diagram of a physics engine configured to provide realistic output for a virtual reality surgical simulator.

FIG. 2 shows an exemplary embodiment of a physics engine configured to provide haptic output from a virtual reality surgical simulator to a connected human machine interface.

FIG. 3 shows a flow diagram of a method for receiving movement information and transmitting the information to a physics engine.

FIG. 4 shows a flow diagram of a method for receiving simulated movement information and generating feedback for a user.

FIG. 5 shows a flow diagram of a method for communicating tactile feedback to a user.

FIG. 6 shows a system diagram of a virtual reality surgical simulator.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

Referring to exemplary FIG. 1, a physics engine for use in a virtual reality surgical simulator may be disclosed. Physics engine 100 may have an interaction calculator 102, a physical scene description 104, and one or more object descriptions 106. In one exemplary embodiment, physical scene description 104 and object descriptions 106 may be computer files accessed by physics engine 100. Physical scene description 104 may contain a description of each of the one or more objects that can have physical interactions in a simulation. In an exemplary embodiment, physical scene description 104 may contain a description of the organs or soft tissue being operated on and any of the one or more tools that may be inserted into a simulated body for use in the simulated surgical procedure. In some embodiments, one or more physical scene descriptions 104 and one or more object descriptions 106 may be stored in a database, and the appropriate scene description 104 and one or more object descriptions 106 may be loaded into physics engine 100 depending on the surgical simulation to be performed

Physics engine 100 may perform kinematic, collision, and deformation calculations in real time to represent realistic motions of the tools, organs, and anatomical environment during a surgical procedure. Physics engine 100 may allow the use of multiple geometric models of the same object. In some embodiments, objects may be represented in physics engine 100 by a mechanical model having mass and constitutive properties, a collision model having a simplified geometry, and a visual model having a detailed geometry and visual rendering parameters. In some embodiments, each object may be represented in separate files or data objects. Physics engine 100 may support the addition and removal of objects during the simulation. As objects are added and removed, physics engine 100 may be updated to reflect the changed physical relationships within the simulated anatomical environment and the properties of different surgical tools inserted into the simulated anatomical environment (for example, the flexibility of tubing versus the rigidity of steel cutting or grasping instruments).

In an exemplary embodiment, each of the organs or soft tissues described in physical scene description 104 may have a corresponding physical object description 106. Each physical object description 106 may have a volumetric nodal point description 108 and a spherical boundary description 110. Volumetric nodal point description 108 may have a simplified geometry containing information about the boundaries of an object to be used by interaction calculator 102 to determine the physical behavior of objects in a simulation. In an exemplary embodiment, spherical boundary description 110 may contain information about the volumetric boundary of an object to be used by interaction calculator 102 to detect collisions between objects (for example, collisions between discrete soft tissues or organs or collisions between a surgical tool and soft tissue).

Referring now to exemplary FIG. 2, a system for providing haptic feedback from collision and interaction calculations generated by physics engine 100 may be disclosed. A human machine interface 200 may be connectively coupled to a virtual reality surgical simulator. Human machine interface 200 may have an input/output processor 202 configured to receive input from a virtual reality surgical simulator and transmit movement outputs from human machine interface 200 to a connected virtual reality surgical simulator. Human machine interface 200 may further have a plurality of hardware elements 204, each of which may have one or more actuators 206 configured to provide physical feedback through one of the plurality of hardware elements 204. Hardware elements 204 may be shaped in any desired form; in some embodiments, hardware elements 204 may be shaped in the form of the surgical instruments to be used in a particular surgical procedure to impart a sense of realism to the simulation. Interaction calculations generated by physics engine 100 may include an amount and direction of force a collision with soft tissue or an organ may impart on a surgical tool. Physics engine 100 may transmit force information to human machine interface 200, and input/output processor 202 may actuate one or more appropriate actuator 206 to impart the appropriate amount of force in the calculated direction on one or more hardware element 204 to give a user real-time tactile feedback about the precise location of a surgical tool being used in a simulation.

Referring generally to exemplary FIGS. 3-5, a method of providing haptic feedback in a surgical simulator may include receiving movement information from a user and transmitting it to a physics engine, performing physics calculations, and communicating feedback information to a user through a tactile medium.

Exemplary FIG. 3 shows a flow diagram of a method 300 of receiving movement information and transmitting the information to a physics engine. An exemplary embodiment of method 300 may be performed by a human machine interface, for example one as described above and as shown in exemplary FIG. 2. In step 302, hardware movement information may be received. Hardware movement information may be generated by a user utilizing one or more hardware elements. In some embodiments, hardware elements may be constructed to have handholds substantially similar to surgical implements, or as desired, with actuators to detect movement and generate an electronic signal corresponding to the physical movement. Hardware movement information may include the amount of force and in which direction it is applied by a user.

In step 304, the hardware movement information may be transmitted to a processor. In step 306, the processor may convert the hardware movement information to simulated movement information. In some exemplary embodiments, analog hardware movement information may be converted to digital simulated movement information. In a final step 308, the simulated movement information may be transmitted to a physics engine. The physics engine may be a processor coupled with a memory which may be configured to accept simulated movement information, perform physics calculations, and provide feedback.

Exemplary FIG. 4 shows a flow diagram of a method 400 of receiving simulated movement information and providing feedback to a user. An exemplary embodiment of method 400 may be performed by a physics engine, for example one as described above and as shown in exemplary FIG. 1. In step 402, simulated movement information may be received. The simulated movement information may have been generated by a user through a human machine interface, for example as described above and shown in FIG. 3.

In step 404, physics calculations such as kinematic, collision, and deformation calculations may be performed. To perform step 404, a scene description, an object description, and an interaction calculator may be utilized. A scene description may contain a description of each of the one or more objects that can have physical interactions in a simulation, for example the locations and orientations of organs and tools in a surgical simulation. Each object within the simulation may have an object description. Each object description may include information describing the object's shape, size, and physical properties. An interaction calculator may determine the simulated forces present if a simulated collision is determined to occur. In step 404, the collision and deformation calculations may alter the scene description and object description.

Step 404 results in generating feedback information. In step 406, feedback information is transmitted via a human machine interface, for example the same interface used to generate the original hardware movement information received in step 302, as described above. In step 408, feedback information is sent a processor system. The processor system may further be coupled to a visual rendering engine which may provide visual feedback via a monitor to the user. The processor system may in addition be coupled to a metrics engine, which may record the simulated movements made and determine how well a simulation was completed.

Exemplary FIG. 5 shows a flow diagram of a method 500 of communicating tactile feedback to a user. An exemplary embodiment of method 500 may be performed by a human machine interface, for example one as described above and as shown in exemplary FIG. 2. In step 502, feedback information is received. Feedback information may have been generated by a simulation, for example, a physics engine as described above and as shown in exemplary FIG. 1. In step 504, the feedback information is converted to one or more actuator commands. In some exemplary embodiments, an output processor may interpret digital feedback information into one or more actuator commands. In step 506, the actuator command is transmitted to a hardware element. The hardware element may contain one or more actuators. In step 504, a processor may determine which of a plurality of actuators situated on one or more hardware elements should receive the actuator command. In some exemplary embodiments, the one or more hardware elements may be constructed to have handholds substantially similar to surgical implements, or as desired, and may be held by a user. In response to the transmittal of an actuator command in step 506, the one or more actuators may exert a force on the one or more hardware elements, thus providing haptic feedback to the user.

Referring to exemplary FIG. 6, physics engine 100 and human-machine interface 200 may be parts of a virtual reality surgical simulator 600. Physics engine 100 may be communicatively coupled to a processing system 602. Processing system 602 may further be communicatively coupled to a rendering engine 604. Rendering engine 604 may render visuals of the simulation, for example to provide visual feedback to a user. Processing system 602 may also be communicatively coupled to a metrics engine 606. Metrics engine 606 may determine how well a simulation was completed. Virtual reality surgical simulator 600 may also include an input device 608 and an output device 610. Input device 608 and output device 610 may be two separate devices or a single integrated device, as desired. In some exemplary embodiments, input device 608 may allow a user to log in, access records of simulations, and select a simulation to perform. In some exemplary embodiments, output device 610 may provide visual feedback to a user, for example, an image of a simulated surgery or the calculated records of completed simulations.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A physics engine for a virtual reality surgery simulator comprising:
an interaction calculator;
a scene description; and
an object description;
wherein said physics engine is configured to receive simulated movement information and perform calculations to produce feedback information to a user, said feedback information being capable of being expressed through at least one of haptic feedback and visual feedback.

2. The physics engine of claim 1, further comprising a human machine interface.

3. The physics engine of claim 2 wherein said human machine interface comprises at least one hardware element, said at least one hardware element further comprising at least one actuator.

4. The physics engine of claim 3 wherein said at least one hardware element is constructed in such a shape and size as to substantially imitate a surgical instrument.

5. The physics engine of claim 3 wherein said at least one actuator is constructed to be capable of providing haptic feedback to a user of said hardware element.

6. The physics engine of claim 3, further comprising an input/output processor.

7. The physics engine of claim 6 wherein said input/output processor is configured to convert analog hardware movement information into digital simulated movement information.

8. The physics engine of claim 6 wherein said input/output processor is configured to convert digital simulated movement information into one or more analog actuator commands.

9. The physics engine of claim 1 wherein said calculations include at least one of: kinematic, collision, and deformation calculations.

10. The physics engine of claim 1 wherein said object description further comprises a volumetric nodal point description and a spherical boundary description.

11. The physics engine of claim 10 wherein said volumetric nodal point description may have a simplified geometry containing information about the boundaries of a simulated object.

12. The physics engine of claim 10 wherein said spherical boundary description may have information about the volumetric boundary of a simulated object.

13. A method for providing haptic feedback in a virtual reality surgical simulator, comprising:
receiving hardware movement information;
performing physics calculations; and
communicating tactile feedback to a user;
wherein said physics calculations comprise performing at least one of kinematic, collision, and deformation calculations; and
wherein said physics calculations are performed using data from at least one of a scene description file and an object description file.

14. The method of claim 13, further comprising:
after receiving hardware movement information:
converting hardware movement information into simulated movement information; and
transmitting simulated movement information to a physics engine

15. The method of claim 13 wherein said hardware movement information is generated by a human machine interface.

16. The method of claim 15 wherein said human machine interface comprises at least one hardware element, said at least one hardware element comprising at least one actuator.

17. The method of claim 13 wherein said step of communicating tactile feedback to a user is performed by a human machine interface, said human machine interface comprising at least one hardware element, said at least one hardware element comprising at least one actuator.

18. The method of claim 13, further comprising providing feedback information to a processing system, said processing system being communicatively coupled to a visual output monitor.

19. The method of claim 18 wherein said processing system is also communicatively coupled to a metrics engine.

20. The method of claim 13, further comprising:
after performing physics calculations:
generating feedback information, said feedback information being readable by a human machine interface;
converting feedback information to one or more actuator commands; and
transmitting said one or more actuator commands to at least one hardware element.
